(19) United States
(12) Patent Application Publication
(10) Pub. No.: US 2006/0122787 A1
(43) Pub. Date: Jun. 8, 2006

(54) Protein structure search system and search method of protein structure

(76) Inventors: Dae-Hee Kim, Daejeon-city (KR); Sung-Hee Park, Daejeon-city (KR); Chan-Yong Park, Daejeon-city (KR); Sun-Hee Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/285,271

(22) Filed: Nov. 21, 2005

(30) Foreign Application Priority Data
Dec. 6, 2004 (KR) 10-2004-0101948

(51) Int. Cl. G06F 19/00

(52) U.S. Cl. 702/19

(57) ABSTRACT

A protein structure searching system including a protein database storing structural characteristics proteins wherein the characteristics include structural characteristics of an entire area and a sub-area of each protein; a data processing unit receiving structural characteristics of an entire area and a sub-area of a target protein from the protein database by using information on the target protein; an entire-area searching unit selecting a predetermined number of proteins having structural characteristics which are similar to those of the entire area of the target protein from the protein database; and a sub-area searching unit selecting a predetermined number of proteins having structural characteristics which are similar to the structural characteristics of the sub-area of the target protein from the protein database.

### CROSS-REFERENCE TO RELATED APPLICATION

This application claims priority to and the benefit of Korean Patent Application 10-2004-0101948 filed in the Korean Intellectual Property Office on Dec. 6, 2004, the entire content of which is incorporated herein by reference.

### BACKGROUND OF THE INVENTION

(a) Field of the Invention

The present invention relates to a protein structure searching system and a method for searching a protein structure, and more particularly relates to a protein structure searching system that search proteins which are similar in structure and a method thereof.

Since proteins with similar structures typically have the same functions, methods for searching a protein the same or similar to a target protein by comparing structures of proteins have been proposed. Comparison between two protein structures in a three-dimensional space has a searching speed problem because of a difficulty in structural arrangement and a problem of many computations in the three-dimensional space.

Structural similarities between all pairs of known protein structures have been measured with respect to location of each atom in a protein and distance between each atom, but this requires a lot of computations and cannot tolerate small errors. Thus, a method for measuring similarities of protein structures using a location of alpha-carbon in a protein has been proposed.

L. Holm and C. Sande expressed a distance between alpha-carbons (C_{α}) using a matrix, divided the matrix into a plurality of sub-matrixes, and compared sub-matrixes of two proteins in “Protein Structure Comparison by alignment of distance matrixes, Journal of Molecular Biology, Vol. 233, 1993”. If the two sub-matrixes are similar to each other, areas to be compared are extended. However, this method takes too much time for comparing protein structures.

In addition, according to another proposed method, the secondary structure of a protein is expressed as vectors and the vectors are used for measuring similarity.

Amit P. Singh and Douglas L. Brutlag proposed an algorithm for comparison of proteins based on a hierarchy of structural representation, from a secondary structure level to an atomic level in “Hierarchical Protein Structure Superposition using both Secondary Structure and Atomic Representation, Proc. Intelligent Systems for Molecular Biology, 1997.” However, this algorithm requires a lot of time for measuring similarity. The above information disclosed in this Background of the Invention section is only for enhancement of understanding of the background of the invention and therefore, it should not be understood that all the above information forms the prior art that is already known in this country to a person or ordinary skill in the art.

### SUMMARY OF THE INVENTION

It is an advantage of the present invention to provide a protein structure searching system and a method thereof for searching proteins with ease by performing fast and efficient comparison of protein structures.

It is another advantage of the present invention to provide a protein structure searching system for searching proteins similar in structure with a protein to be searched (hereinafter, referred to as a “target protein”) by approximating locations of alpha carbon atoms (hereinafter, referred to as a “C_{α} atom”) of which a protein is composed in the three-dimensional space.

It is still another advantage of the present invention to provide a fast and efficient protein structure searching system representing a protein as a matrix using a location of a C_{α} atom, dividing locations of C_{α} atoms in each protein into an entire-area matrix and a sub-area matrix obtained by using piecewise linear regression and storing the entire-area matrix and the sub-area matrix of the protein in a protein database, and comparing similarity between structural characteristics of a target protein with structural characteristics of the sub-area after comparing similarity between the structural characteristics of a target protein with a structural characteristics of the entire area.

In one aspect of the present invention, a protein structure searching system including a protein database, a data processing unit, an entire-area searching unit, and a sub-area searching unit. The protein database stores structural characteristics of proteins, the characteristics including structural characteristics of an entire-area and a sub-area of each protein. The data processing unit receives structural characteristics of an entire area and a sub-area of a target protein, which is to be searched, from the protein database by using information on the target protein. The entire-area searching unit selects a predetermined number of proteins having structural characteristics which are similar to those of the entire area of the target protein from the protein database. The sub-area searching unit selects a predetermined number of proteins having structural characteristics which are similar to the structural characteristics of the sub-area of the target protein from the protein database.

In another aspect of the present invention, a method for searching a protein is provided. In the method, structural characteristics including structural characteristics of an entire area and a sub-area of a target protein, which is to be searched, are retrieved from a protein database, a predetermined number of proteins which have a structural similarity with the structural characteristics of the entire area of the target protein is selected, and a predetermined number of proteins which have a structural similarity with the structural characteristics of the sub-area of the target protein is selected.

### BRIEF DESCRIPTION OF THE DRAWINGS

FIG. 1 is a schematic diagram of a protein structure searching system according to a first embodiment of the present invention.

FIG. 2 is a schematic view of a protein data processing unit of the protein structure searching system according to the first embodiment of the present invention.

FIG. 3 is a flowchart of a method for processing protein data performed by the protein data processing unit of FIG. 2.

FIG. 4 is a curve representing C_{α} distribution approximated by 1×16 transformation matrix (A_{1*16} matrix) in an entire area of a protein.

FIG. 5 is a schematic diagram illustrating a C_{α} distribution area divided into 16 sub-areas in the two-dimensional space.

FIG. 6 is a schematic diagram illustrating a C_{α} distribution area divided into 64 sub-areas in the three-dimensional space.

FIG. 7 shows a plane representing C_{α} distribution approximated by an A_{1*3} matrix in one sub-area of the 64 sub-areas of FIG. 5.

FIG. 8 is a flowchart of a method for searching a protein according to a second embodiment of the present invention.

FIG. 9 is a flowchart of a method for predicting protein functions according to a third embodiment of the present invention.

### DETAILED DESCRIPTION OF THE PREFERRED EMBODIMENTS

An embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention.

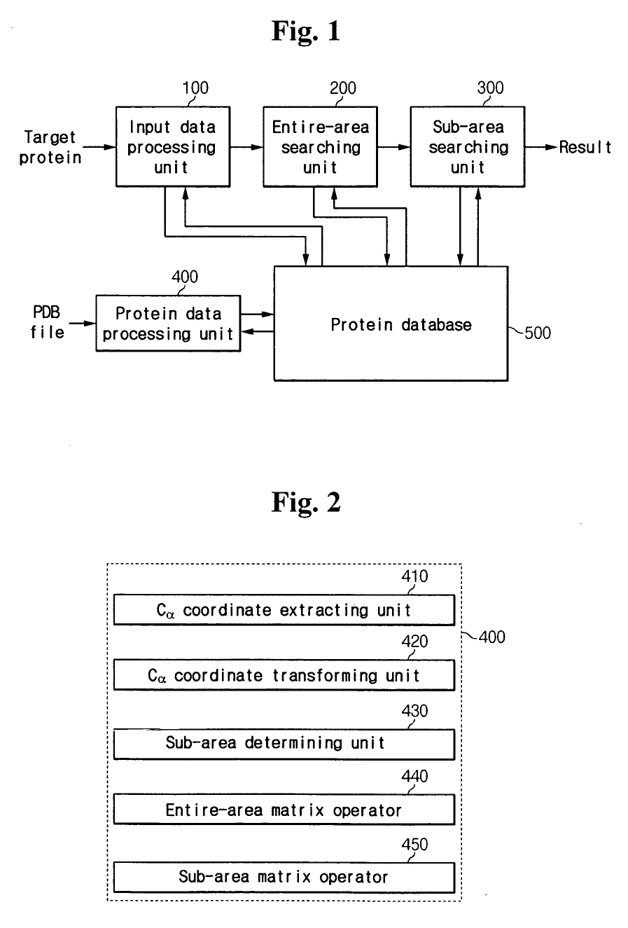

A protein structure searching system according to a first embodiment of the present invention will now be described with reference to FIG. 1.

FIG. 1 shows a configuration of the protein structure searching system according to the first embodiment of the present invention.

The protein structure searching system includes an input data processing unit 100, an entire-area searching unit 200, a sub-area searching unit 300, a protein data processing unit 400, and a protein database 500.

When a protein to be searched is input, the input data processing unit 100 transmits information on the protein to be searched (hereinafter, referred to as a target protein) and receives characteristics of the target protein from the protein database 500. The characteristics of the target protein are expressed by an entire-area matrix and a sub-area matrix. The entire-area matrix and sub-area matrix will be described in more detail later.

The entire-area searching unit 200 receives characteristics of an entire-area structure of the target protein, and selects a predetermined number of proteins which are similar to the target protein in structure from among other proteins stored in the protein database 500 by using the received characteristics of the entire-area structure.

The sub-area searching unit 300 receives characteristics of a sub-area structure of the target protein, selects a predetermined number of proteins which are similar to the target protein in structure from among other proteins selected by the entire-area searching unit 200 by using the characteristics of the sub-area, and prioritizes a final searching result.

The protein data processing unit 400 receives protein data, extracts structural characteristics of the target protein, and stores the extracted structural characteristics in the protein database 500.

The protein database 500 stores protein data processed by the protein data processing unit 400, and transmits the structural characteristics of the target protein to the input data processing unit 100 when receiving a request from the input data processing unit 100. When the structural characteristics of the target protein are not stored in the protein database 500, the protein database 500 requests the protein data processing unit 400 to extract the structural characteristics of the target protein, and receives and stores the requested structural characteristics of the target protein from the protein data processing unit 400.

Table 1 shows a data table input to the protein database of the protein structure searching system according the first embodiment of the present invention.

TABLE 1

| | | | | Min, Max value for each C_{α} |
|---|---|---|---|---|
| Protein | C_{α}coordinate | Entire-area | Sub-area matrix A₁*₃ | coordinate Ex)[xₘᵢₙ, xₘₐₓ, |
| name | Ex) P1 = [x, y, z] | matrix A₁*₁₆ | Ex) A = [1, 2, 3] | yₘᵢₙ, yₘₐₓ, z_{min,} zₘₐₓ |
| ace | 12.3 13.4 21.5 | 1 2 3 4 5 6 7 8 | 1 2 3 | −12.5 45.3 |
| | 82.3 23.4 31.5 | 9 0 1 2 3 4 5 6 | 5 6 7 | −28.1 74.2 |
| | 62.3 33.4 41.5 | | 9 10 11 | −33.3 55.5 |
| | 32.3 43.4 51.5 | | 92 12 13 | |
| | 53.4 61.5 | | | |
| acb | | | | |
| abi | | | | |

As shown in Table 1, the protein data table includes a protein name, a C_{α} coordinate, an A_{1*16} entire-area matrix, an A_{1*3} area-specific matrix, and maximum and minimum values for each C_{α} coordinate.

In the C_{α} coordinate item, C_{α} coordinates of amino acids of which the target protein is composed are parsed, and a C_{α} position is input after C_{α} atoms are structurally arranged and a center of mass is relocated. The C_{α} coordinates estimated after the relocation in the Table 1 are input as x, y, and z coordinates of each C_{α} atom.

Each term of the entire-area matrix A_{1*16} obtained from an arranged position of C_{α} is input to the entire-area matrix A_{1*16} item. Each term of the sub-area matrix A_{1*3} corresponding to the respective 64 sub-areas is input to the sub-area matrix A_{1*3} item. Maximum and minimum values of the C_{α} position are input to the maximum and minimum values for each C_{α} coordinate item for defining areas.

The protein information processing unit 400 will now be described in more detail with reference to FIG. 2.

As shown in FIG. 2, the protein information processing unit 400 includes a C_{α} coordinate extracting unit 410, a C_{α} coordinate transforming unit 410, a sub-area determining unit 430, an entire-area matrix calculating unit 440, and a sub-area matrix calculating unit 450.

The C_{α} coordinate extracting unit 410 parses C_{α} coordinates of a target protein and extracts the C_{α} coordinates. The C_{α} coordinate transforming unit 420 places the origin at a center of the target protein by analyzing principal components of the C_{α} coordinates of the target protein, moves the C_{α} coordinates accordingly, and inputs moved C_{α} coordinates to the protein database 500. The sub-area determining unit 430 obtains a maximum value and a minimum value of the C_{α} coordinates and stores the maximum and minimum values in the protein database 500. In addition, the sub-area determining unit 430 determines sub-areas by dividing a C_{α} coordinate area into 64 sub-areas. The entire-area matrix calculating unit 440 calculates an entire-area matrix of the target protein and stores a calculated result in the protein database 500. The sub-area matrix calculating unit 450 calculates a sub-area matrix of the target protein for each sub-area and stores a calculated result in the protein database 500.

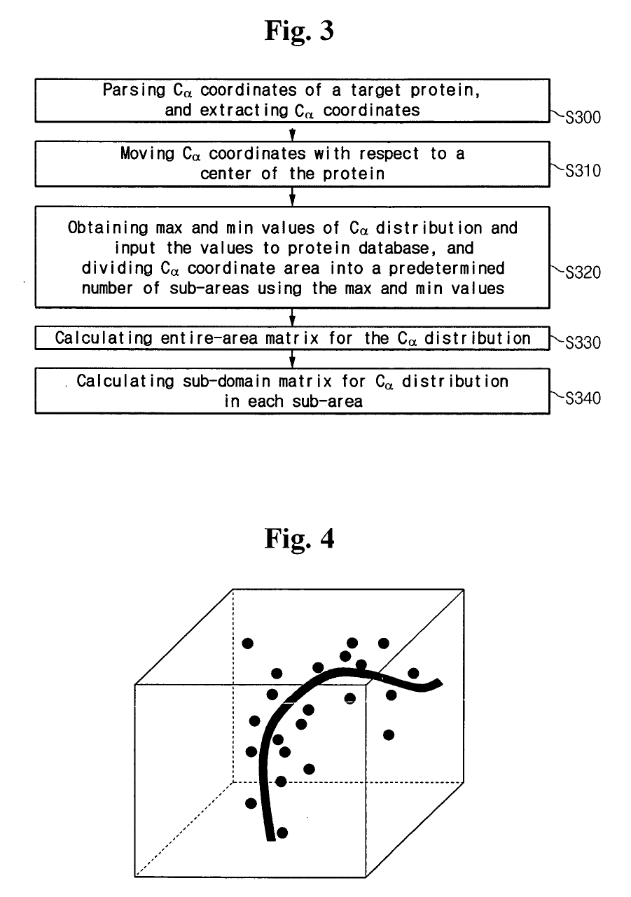

A method for processing protein data performed by the protein data processing unit 400 will now be described in more detail with reference to FIG. 3.

The information on a protein in the embodiment of the present invention includes information on priority of each protein and locations of atoms, but it should be understood that the present invention is not limited thereto. A protein databank (PDB) file is input as information on a protein according to the embodiment of the present embodiment. Each protein has a PDB that includes priority of the protein and a location of each atom.

A method for processing protein data according to an embodiment of the present invention includes the following steps: extracting C_{α} coordinates by parsing C_{α} coordinates of a target protein, and moving C_{α} coordinates after placing the origin at the center of the target protein in step s310; obtaining maximum and minimum values of a C_{α} distribution and inputting the values to the protein database, and determining sub-areas by dividing a C_{α} coordinate area into a predetermined number of sub-areas using the maximum and minimum values of the C_{α} distribution in step s320; calculating an entire-area matrix with respect to the C_{α} distribution of the target protein in step s330; and calculating sub-area matrices for the predetermined number of sub-areas and the C_{α} distribution in the sub-area, respectively, in step s340.

A method for processing protein information will now be described in more detail.

A PDB file of a target protein is input, and C_{α} coordinates of the target protein are parsed and extracted in step s300.

Principal component analysis (PCA) is performed for structural arrangement, and a center of the target protein becomes an origin of the C_{α} coordinate. Then, C_{α} coordinates moved with respect to the origin are input to the protein database in step s310.

When moving C_{α} coordinates, a transformation matrix S is obtained and a coordinate centered on the protein is moved to (0, 0, 0). Then, the corresponding coordinate of a C_{α} atom is obtained.

If we assume that C_{α} coordinates of the corresponding protein are set to be fixed points P₁, P₂, P₃, . . . , P_{N} (where Pᵢ=(xᵢ,yᵢ,zᵢ)), an average location of the fixed points may be obtained by Equation 1.

$$m = \frac{1}{N} {\sum }_{i = 1}^{N} {P}_{i} \qquad Equation 1$$

where N is the number of fixed points.

A 3*3 covariance matrix C of the fixed points may be obtained by Equation 2.

$$C = \frac{1}{N} {\sum }_{i = 1}^{N} ( {P}_{i} - m ) {( {P}_{i} - m )}^{T} \qquad Equation 2$$

where (Pᵢ−m)^{T} represents a transposed matrix of (Pᵢ−m).

An eigenvector of the covariance matrix C is obtained to calculate the transformation matrix S for structure arrangement. A root value of a result of Equation 3 is set to be an eigenvalue so as to obtain the eigenvector.
det(C−λI)=0 Equation 3

where is an eigenvalue, and I is a unit matrix.

An eigenvector for V is obtained by substituting eigenvalues to Equation 4, from the largest to the smallest (here, 1>2>3)
(C−λI)Vᵢ=0 Equation 4

where Vᵢ is an eigenvector.

By using the eigenvector Vᵢ of Equation 4, a 3*3 transformation matrix S may by defined by Equation 5.

$$S = ( \frac{{V}_{1}}{‖ {V}_{1} ‖} , \frac{{V}_{2}}{‖ {V}_{2} ‖} , \frac{{V}_{3}}{‖ {V}_{3} ‖} ) \qquad Equation 5$$

Locations of all the fixed points Pᵢ may be moved by using the transformation matrix S of Equation 5 as shown in Equation 6 such that a center of a protein becomes the origin of the coordinate.
Pᵢ′=Pᵢ*S−m Equation 6

where a fixed point Pᵢ′ represents a coordinate of the fixed point Pᵢ after being moved.

Maximum and minimum values of each coordinate are obtained and input to the protein database, and a C_{α} coordinate area is divided into a predetermined number of sub-areas by using maximum and minimum values of the C_{α} distribution such that sub-areas are determined in step s320. The maximum and minimum values of each coordinate represent the size of an area in which the fixed points are distributed.

Maximum and minimum values of a protein C_{α} for each coordinate may be defined by Equations 7 and 8.
A maximum value of the protein C_{α} (Xₘₐₓ, Yₘₐₓ, Zₘₐₓ)=(Max x components for all the Pᵢ values, Max y components for all the Pᵢ values, Max z components for all the Pᵢ values) Equation 7
A minimum value of a protein C_{α} (Xₘᵢₙ, Yₘᵢₙ, Zₘᵢₙ)=(Min x components for all the Pᵢ values, Min y components for all the Pᵢ values, Min z components for all the Pᵢ values) Equation 8

A coordinate matrix of the protein C_{α} for the entire area of the target protein is obtained and input to the protein database in step s330.

An approximation curve of the C_{α} coordinates in the entire area of the corresponding protein may be expressed by Equation 9.
z=a₀x³+a₁y³+a₂x³y³+a₃x³y²+a₄x³y+a₅y³x²+a₆y³x+a₇x²y²+a₈x²y+a₉x²+a₁₀y²+a₁₁y²x+a₁₂xy+a₁₃x+a₁₄y+a₁₅ Equation 9

where variables x, y, and z respectively represent x, y, and z coordinates of the protein C_{α}.

As shown in Equation 9, an A_{1*16} matrix may be obtained by Equation 10 using coefficients a₀ to a₁₅ of each member in Equation 9.
A_{1*16}=[a₀, a₁, a₂, a₃, a₄, a₅, a₆, a₇, a₈, a₉, a₁₀, a₁₁, a₁₂, a₁₃, a₁₄, a₁₅] Equation 10

The respective members a₀ to a₁₅ of the A_{1*16} matrix are obtained by Equation 11.
X=Af(Y) Equation 11

where X is composed of combinations of z coordinates of Pᵢ, and f(Y) represents a matrix formed by x and y coordinates of Pᵢ as shown in Equation 12.

$$f ( Y ) = [ \begin{matrix}{x}^{3} \\ {y}^{3} \\ {x}^{3} ⋆ {y}^{3} \\ {x}^{3} ⋆ {y}^{2} \\ {x}^{3} ⋆ y \\ {y}^{3} ⋆ {x}^{2} \\ {y}^{3} ⋆ x \\ {x}^{2} ⋆ {y}^{2} \\ {x}^{2} ⋆ y \\ {x}^{2} \\ {y}^{2} \\ {y}^{2} ⋆ x \\ x ⋆ y \\ x \\ y \\ 1\end{matrix} ] \qquad Equation 12$$

A matrix of Equation 14 may be obtained by a matrix that minimizes a result of Equation 13 by using the least squares method.

$$\begin{matrix}e = {E ( ‖ {X}_{i} - Af ( {Y}_{i} ) ‖ )}^{2} & Equation 13 \\ A = {[ \frac{1}{N} {\sum }_{i = 1}^{N} {X}_{i} {f ( {Y}_{i} )}^{t} ] [ \frac{1}{N} {\sum }_{i = 1}^{N} f ( {Y}_{i} ) {f ( {Y}_{i} )}^{t} ]}^{- 1} & Equation 14\end{matrix}$$

where N is the number of input samples.

FIG. 4 shows a C_{α} distribution of the corresponding protein in three-dimensional space. The curve in FIG. 4 shows the C_{α} distribution of the corresponding protein, the curve being approximated by A_{1*16} by Equation 9 through Equation 14.

The A_{1*16} approximation curve shown in FIG. 4 represents characteristics of the C_{α} distribution of the corresponding protein. In other words, it represents structural characteristics of the corresponding protein.

The protein C_{α} distribution area is divided into 64 sub-areas, and then a C_{α} coordinate matrix for each sub-area is obtained and input to the protein database in step s340.

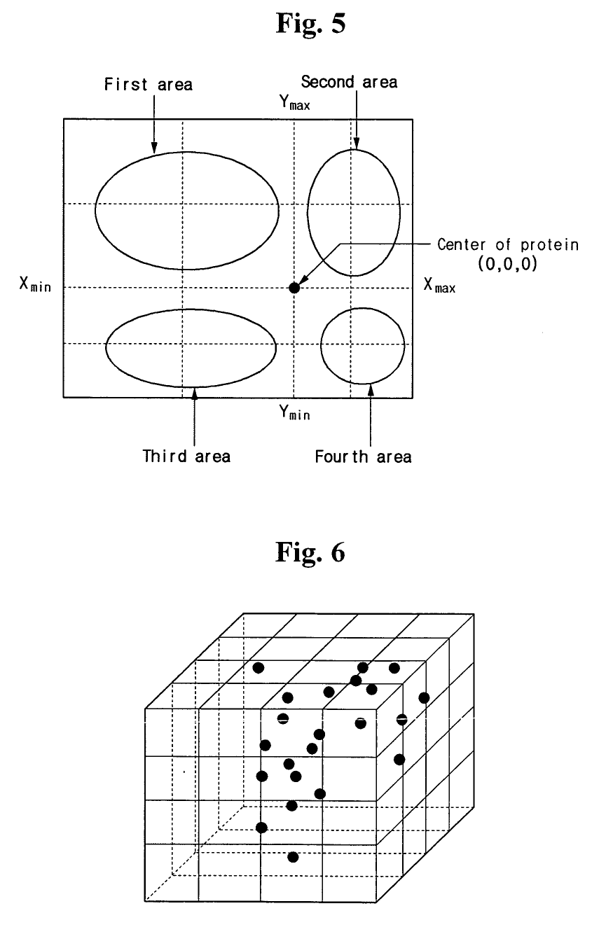

FIG. 5 shows 16 sub-areas divided from a C_{α} distribution area in a two-dimensional space.

A method for dividing a C_{α} distribution area into 64 sub-areas will now be described in more detail with reference to FIG. 5.

As show in FIG. 5, a two-dimensional plane is divided into 4 areas based on a minimum value of the x coordinate (xₘᵢₙ), a minimum value of the y coordinate (yₘᵢₙ), a maximum value of the x coordinate (xₘₐₓ), and a maximum value of the y coordinate (yₘₐₓ) with respect to the origin (0, 0, 0) which is a center of the C_{α} distribution of the corresponding protein. The 4 respective areas are each divided by 4 such that the two-dimension plane is divided into 16 sub-areas. When minimum and maximum values of the z coordinate are added and thus the two-dimensional space is extended to three-dimensional space, 64 sub-areas are generated.

FIG. 6 shows the C_{α} distribution of the corresponding protein. The C_{α} distribution is divided into 64 sub-areas in the three-dimensional space.

The sub-areas use an A_{1*3} matrix. An approximation curve for obtaining an A_{1*3} matrix for a protein may be defined by Equation 15.
z=a₀x+a₁y+a₂ Equation 15

In this instance, the A_{1*3} matrix becomes [a₀, a₁, a₂].

C_{α} coordinates included in each sub-area are substituted to Equation 11 to 14 and an A_{1*3} matrix for each sub-area is calculated. The respective A_{1*3} matrices are input to the protein database. Here,

$$[ \begin{matrix}x \\ y \\ 1\end{matrix} ]$$

is used as f(Y).

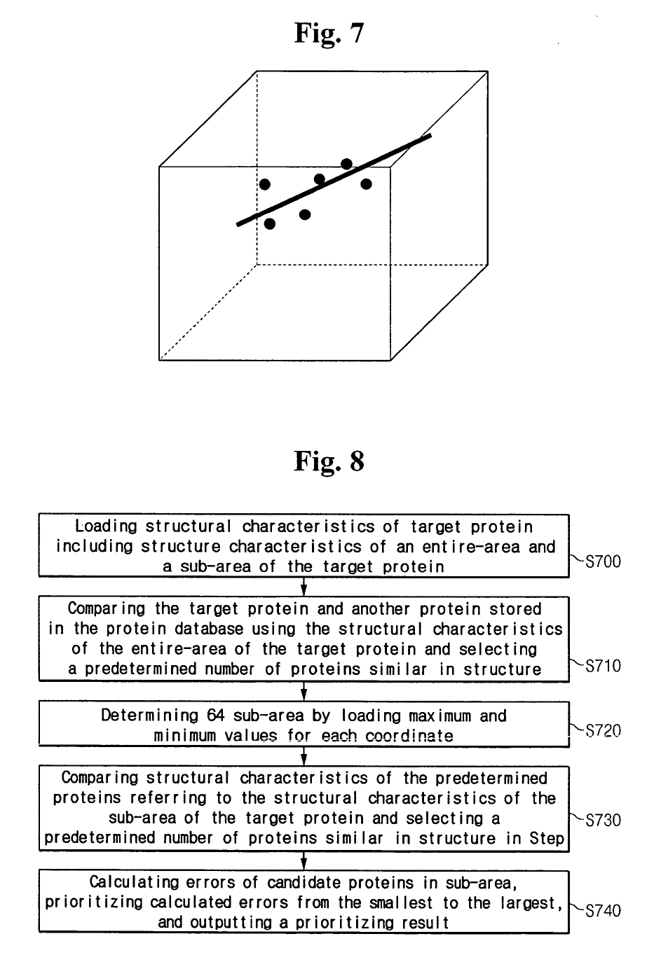

FIG. 7 is a plane representing the C_{α} distribution approximated by A_{1*3} in one of the 64 sub-areas of FIG. 6.

A method for searching proteins will now be described in more detail according to a second embodiment of the present invention.

FIG. 8 shows a flowchart of the method for searching proteins according to the second embodiment of the present invention.

The method includes loading structural characteristics of a target protein including structure characteristics of an entire area and a sub-area of the target protein in step s700; comparing the target protein and another protein stored in the protein database referring to the structural characteristics of the entire area of the target protein and selecting a predetermined number of proteins similar in structure in step s710; and comparing structural characteristics of the predetermined proteins referring to the structural characteristics of the sub-area of the target protein and selecting a predetermined number of proteins similar in structure in step s730.

In step s700, when information on the target protein is input, the A_{1*16} matrix as the structural characteristics of the entire-area structure and the A_{1*3} matrix as the structural characteristics of the 64 sub-areas are loaded, and Xₘᵢₙ, Yₘᵢₙ, Zₘᵢₙ, Xₘₐₓ, Yₘₐₓ, and Zₘₐₓ are loaded to determine areas.

In step s700, a PDB file is used as protein information according to the embodiment of the present invention.

When data (A_{1*16} matrix for the entire area, A_{1*3} matrix for the sub-area, Xₘᵢₙ, Yₘᵢₙ, Zₘᵢₙ, Xₘₐₓ, Yₘₐₓ, and Zₘₐₓ) for a protein to be input are not stored in the protein database, the method for processing protein data of FIG. 3 is performed to obtain related data for the input protein, and the related data are stored in the protein database in steps s300 to s340 before proceeding with further steps.

Errors in comparison of other proteins against each other in the protein database are calculated by Equation 16 in step s710, using the A_{1*16} matrix loaded as the structural characteristics of the entire area.

$$error = \frac{1}{n} {\sum }_{i = 1}^{n} ( \vert {X}_{i} - Af ( {Y}_{i} ) \vert ) \qquad Equation 16$$

where n denotes the number of input samples, Xᵢ denotes the z coordinate of another protein Pᵢ stored in the protein database, f(Yᵢ) denotes a matrix formed by x and y coordinates of the protein Pᵢ, and A denotes a matrix of a target protein.

Errors of all the proteins in the protein database are obtained and all the proteins stored in the protein database are prioritized according to the size of the errors, from smallest to largest, in step s710. The smallest error implies high similarity between a target protein and the protein Pᵢ.

In step s730, errors in candidate proteins selected for the respective A_{1*3} matrices loaded for the 64 sub-areas are calculated by Equation 17.

$$error = \frac{1}{{n}_{1}} {\sum }_{i = 1}^{{n}_{1}} ( \vert {X}_{i} - Af ( {Y}_{i} ) \vert ) + \frac{1}{{n}_{2}} {\sum }_{i = 1}^{{n}_{2}} ( \vert {X}_{i} - Af ( {Y}_{i} ) \vert ) + … + \frac{1}{{n}_{64}} {\sum }_{i = 1}^{{n}_{64}} ( \vert {X}_{i} - Af ( {Y}_{i} ) \vert ) \qquad Equation 17$$

where nₙ denotes the number of input samples, Xₙ denotes a combination of the z coordinate of a protein Pᵢ in each sub-area, and f(Yᵢ) denotes a matrix formed by x and y coordinates of the protein Pᵢ in each sub-area.

Determining 64 sub-areas by loading maximum and minimum values for each coordinate (in step s720) may be added to the method for searching proteins of FIG. 8. In step s720, predetermined candidate proteins with high similarity to the target protein are selected from among proteins orderly stored in the protein database, and maximum and minimum values for each coordinate are loaded for measuring exact similarity between the target protein and the candidate proteins.

After errors of the candidate proteins in the sub-areas are calculated, the calculated errors are prioritized, from the smallest to the largest. The smallest error implies the highest similarity, and prioritizing a protein searching result based on the calculated errors and outputting a prioritizing result (step s740) may be added to the method for searching protein of FIG. 8.

On the other hand, the method for searching proteins may be used as a method for predicting functions of a novel protein according to an embodiment of the present invention.

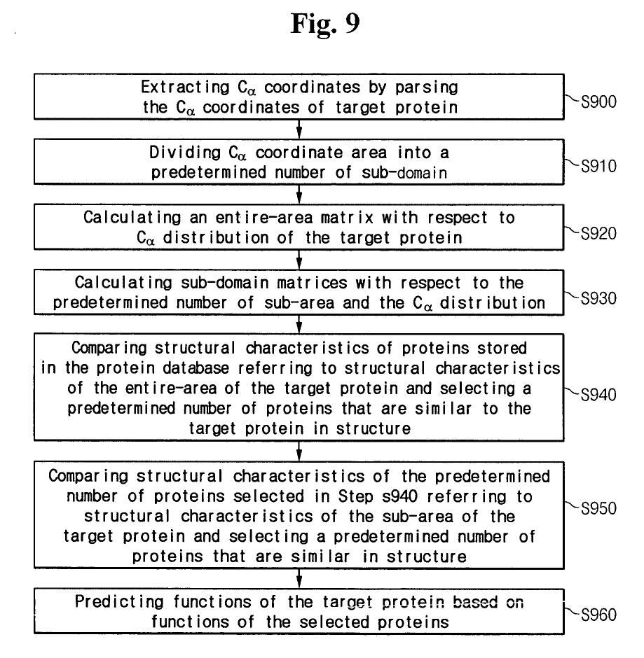

FIG. 9 shows a flowchart of a method for predicting protein functions according to a third embodiment of the present invention.

The method for predicting the protein functions includes extracting C_{α} coordinates by parsing the C_{α} coordinates of a target protein in step s900; determining sub-areas by dividing a C_{α} coordinate area into a predetermined number of sub-areas in step s910; calculating an entire-area matrix with respect to C_{α} distribution of the target protein in step s920; calculating sub-area matrices with respect to the predetermined number of sub-areas and the C_{α} distribution in step s930; comparing structural characteristics of proteins stored in the protein database referring to structural characteristics of the entire area of the target protein and selecting a predetermined number of proteins that are similar to the target protein in structure in step s940; comparing structural characteristics of the predetermined number of proteins selected in step s940 referring to structural characteristics of the sub-areas of the target protein and selecting a predetermined number of proteins that are similar in structure in step s950; and predicting functions of the target protein based on functions of the selected proteins in step s960.

In other words, similar to the method for searching proteins according to the second embodiment of the present invention, the method for predicting protein functions according to the third embodiment of the present invention includes extracting characteristics of the target protein and searching a similar protein by comparing structural characteristics between the target protein and proteins stored in the protein database. When the two proteins are similar in structure, they may be similar in function. Therefore, a function of the target protein may be predicted by analyzing functions of the searched proteins.

Distribution of C_{α} atoms may be approximated in three-dimensional space such that proteins similar in structure may be efficiently searched by using piecewise linear regression according to the embodiments of the present invention.

According to the embodiments of the present invention, the PCA is used for arranging proteins, and characteristics of proteins are extracted in advance and stored in the protein database. Further, structural comparison between proteins is performed in an entire area and a sub-area such that searching speed becomes very fast in a massive protein database.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A protein structure searching system comprising:
a protein database storing structural characteristics of proteins, the characteristics including structural characteristics of an entire area and a sub-area of each protein;
a data processing unit receiving structural characteristics of an entire area and a sub-area of a target protein, which is to be searched, from the protein database by using information on the target protein;
an entire-area searching unit selecting a predetermined number of proteins having structural characteristics which are similar to those of the entire area of the target protein from the protein database; and
a sub-area searching unit selecting a predetermined number of proteins having structural characteristics which are similar to the structural characteristics of the sub-area of the target protein from the protein database.

2. The protein structure searching system of claim 1,
wherein structural characteristics of the entire area are represented as an approximation curve in which locations of alpha-carbon atoms (hereinafter, referred as “C_{α} ”) of each amino acid of which the target protein is composed are approximated by the following equation:
z=a₀x³+a₁y³+a₂ₓ³y³+a₃x³y²+a₄x³y+a₅y³x²+a₆y³x+a₇x²y²+a₈x²y+a₉x²+a₁₀y²+a₁₁y²x+a₁₂xy+a₁₃x+a₁₄y+a₁₅
(where parameters x, y, and z denote x, y, and z coordinates of the target protein C_{α}, respectively).

3. The protein structure searching system of claim 1,
wherein, when C_{α} positions in amino acids of which the target protein is composed are divided into predetermined sub-areas, structural characteristics of the sub-area in an approximation plane in which C_{α} positions of the respective sub-areas are approximated by the following equation:
z=a₀x+a₁y+a₂
(where parameters x, y, and z denote x, y, and z coordinates of the C_{α} position of the target protein, respectively).

4. The protein structure searching system of claim 2,
wherein structural characteristics of the entire area are represented as an A_{1*16} matrix=[a₀, a₁, a₂, a₃, a₄, a₅, a₆, a₇, a₈, a₉, a₁₀, a₁₁, a₁₂, a₁₃, a₁₄, a₁₅] derived from each member of the equation.

5. The protein structure searching system of claim 3,
wherein structural characteristics of the sub-area are represented as an A_{1*3} matrix=[a₀, a₁, a₂] derived from the equation.

6. The protein structure searching system of claim 2,
wherein the entire-area searching unit determines a structural similarity of proteins from a distance of C_{α} positions of proteins stored in the protein database on the approximation curve.

7. The protein structure searching system of claim 3,
wherein the sub-area searching unit determines a structural similarity of proteins with reference to a distance of C_{α} positions of proteins stored in the protein database on the approximation plane.

8. The protein structure searching system of claim 1, further comprising a protein data processing unit extracting structural characteristics of a protein and storing the extracted structural characteristics in the protein database.

9. The protein structure searching system of claim 8, wherein the protein data processing unit comprises:
a C_{α} coordinate extracting unit parsing C_{α} coordinates of a protein and extracting C_{α} coordinates of the protein;
a C_{α} coordinate transforming unit moving the C_{α} coordinates of the protein with respect to a center of a protein;
a sub-area determining unit dividing a C_{α} coordinate area into a predetermined number of sub-areas;
an entire-area matrix operator calculating an entire-area matrix of the protein; and
a sub-area operator calculating a sub-area matrix of each sub-area of the protein.

10. A method for searching a protein, comprising:
retrieving structural characteristics including structural characteristics of an entire area and a sub-area of a target protein, which is to be searched, from a protein database;
selecting a predetermined number of proteins which have a structural similarity with the structural characteristics of the entire area of the target protein; and
selecting a predetermined number of proteins which have a structural similarity with the structural characteristics of the sub-area of the target protein.

11. The method of claim 10, wherein
the structural characteristics of the entire area are represented as an approximated curve in which C_{α} positions of amino acids of which the target protein is composed are approximated by the following first equation:
z=a₀x³+a₁y³+a₃x³y³+a₃x³y²+a₄x³y+a₅y³x²+a₆y³x²+a₈x²y+a₉x²a₁₀y²+a₁₁y²x+a₁₂xy+a₁₃x+a₁₄y+a₁₅
(where parameters x, y, and z respectively represent x, y, and z coordinates of a C_{α} location of a target protein), and
the structural characteristics of the sub-area are represented as an approximation plane in which C_{α} positions of amino acids of which the target protein is composed are approximated by the following second equation when the C_{α} positions of the respective amino acids are divided into a predetermined number of sub-areas:
z=a₀x+a₁y+a₂
(where parameters x, y, and z respectively represent x, y, and z coordinates of a C_{α} location of a target protein).

12. The method of claim 11, wherein
the structural characteristics of the entire area are represented as an A_{1*6}matrix=[a₀, a₁, a₂, a₃, a₄, a₅, a₆, a₇, a₈, a₉, a₁₀, a₁₁, a₁₂, a₁₃, a₁₄, a₁₅], derived from the first equation, and
the structural characteristics of the sub-area are represented as an A_{1*3} matrix=[a₀, a₁, a₂], derived from the second equation.

13. The method of claim 10, wherein the selecting of the proteins using the structural characteristics of the entire area is performed by calculating a distance between C_{α} coordinates of other proteins on the approximation curve given by the first equation.

14. The method of claim 10, wherein the selecting of the proteins using the structural characteristics of the sub-area is performed by calculating a distance between C_{α} coordinates of other proteins on the approximation plane given by the second equation.

15. The method of claim 10, further comprising, when structural characteristics of a target protein are not stored in a protein database, extracting the structural characteristics of the target protein and storing the extracted structural characteristics in the protein database.

16. The method of claim 15, wherein the extracting of the structural characteristics comprises:
parsing C_{α} coordinates of a target protein and extracting Ca coordinates;
moving C_{α} coordinates of the protein with respect to a center of the protein;
determining a sub-area by dividing a C_{α} coordinate area into a predetermined number of sub-areas;
calculating an entire-area matrix of a C_{α} distribution of the protein; and
calculating sub-area matrices for the predetermined number of sub-areas, respectively, of the C_{α} distribution of the protein.

17. A method for predicting a protein function, comprising:
parsing C_{α} coordinates of a target protein and extracting C_{α} coordinates;
dividing a C_{α} coordinate area into a predetermined number of sub-areas;
calculating an entire-area matrix of a C_{α} distribution of the protein;
calculating sub-area matrices for the predetermined number of sub-areas, respectively, of the C_{α} distribution of the protein;
comparing structural characteristics of other proteins stored in a protein database using the structural characteristics of the entire area of the protein, and selecting a predetermined number of proteins similar in structure with each other;
comparing structural characteristics of the predetermined number of proteins using the structural characteristics of the sub-area of the protein, and selecting a predetermined number of proteins similar in structure with each other; and
predicting a function of a target protein from functions of the selected proteins.
